(19) United States
(12) Patent Application Publication
(10) Pub. No.: US 2002/0180690 A1
(43) Pub. Date: Dec. 5, 2002

(54) Method and device for self powered computer input device

(76) Inventor: Janardhana Swamy, San Jose, CA (US)

Correspondence Address: SUN MICROSYSTEMS INC, 901 SAN ANTONIO RD, MS PALO1-521, PALO ALTO, CA, 94303, US

(21) Appl. No.: 09/871,323

(22) Filed: May 30, 2001

(51) Int. Cl. G09G 5/00; G09G 5/08

(52) U.S. Cl. 345/156

(57) ABSTRACT

Methods and apparatus for a self-powered computer peripheral device are provided. Mechanical energy caused by motion of the device is converted into electrical energy for the operation of the device. The motion of the device may be caused by human energy (e.g., hand movement). The electrical energy may be stored.

### FIELD OF THE INVENTION

This invention relates to methods and apparatus for powering peripheral devices, more specifically, to methods and apparatus for powering peripheral devices by converting mechanical energy from device movement into electrical energy for use by the same device.

Sun, Sun Microsystems, Sun logo, Java, and all Java-based trademarks and logos are trademarks or registered trademarks of Sun Microsystems, Inc. in the United States and other countries. All SPARC trademarks are used under license and are trademarks of SPARC International, Inc. in the United States and other countries. Products bearing SPARC trademarks are based upon an architecture developed by Sun Microsystems, Inc.

### BACKGROUND OF THE INVENTION

As the use of computers becomes ubiquitous in all phases of professional and personal life, and as graphical user interfaces become increasingly popular for both personal computers (PCs) and workstations, ease of operating and using peripheral devices with a host system has become a fundamental element to the successful operation of the overall system. The variety of peripheral devices has expanded dramatically with the increasing power available from the microprocessors available for such systems. Peripherals such as keyboards, mice, trackballs, touchpads, gamepads, joysticks, remote controllers, and so on are well-known for use with host systems of many types, including PCs, workstations, and other types of microprocessor-controlled devices such as video game systems and other office or household devices.

To operate in conventional environments, each of these peripheral devices is connected to its host system via a hardware port through which the peripherals communicate with the host system and derive operating power. Connections through hardware ports suffer from some limitations. For example, most host systems have only a limited number of available ports which typically cannot be shared by multiple peripherals. In addition, a hard-wired device limits the range of movements of the peripheral device and therefore, causes inconvenience to users. Furthermore, the amount of hardware, e.g., wires, may undesirably clutter the user's work space.

Devices which communicate with their host systems without hard-wired connections are known in the art. Transmission of signals between a cordless device and its host system typically requires provision of power sources within the cordless device itself since power cannot be derived from the host system absent physical wiring between the host system and the cordless peripheral device. Thus, cordless devices usually require a power supply such as batteries to be carried within the cordless devices themselves. The use of power supplies often adds to the physical size of the cordless device as well as the weight of the device. In addition, since the system within the cordless device typically requires more power than can reasonably be expected from a significant lifetime of the battery supply (for instance, depending on the size and capacity of the battery supply or the size and weight limitations of the cordless device), cordless devices generally require battery replacements or re-charging after a period of use.

### SUMMARY OF THE INVENTION

This invention relates to apparatus and methods for a self-powered computer peripheral device. In accordance with the invention, when a peripheral device is set into motion by external energy, the mechanical energy from that motion is converted into electrical energy by the peripheral device. The electrical energy is then used by the device to supply power to the internal circuitry of the device. For example, a human hand moves a computer mouse, thus transferring human energy to the mouse. The movement of the mouse (or the mouse ball) causes mechanical energy which is then converted into electrical energy using, e.g., a dynamo. In one embodiment, the electrical energy is stored in a power-storing device such as a battery, so that the stored electrical energy can be made available when, for example, circuit operation is required but no device movement is involved (e.g., clicking mouse buttons) or after the device has been idle for a period of time.

This summary is not intended to limit the scope of the invention, which is defined solely by the claims attached hereto.

### BRIEF DESCRIPTION OF THE DRAWINGS

FIG. 1 shows a wheel of a conventional mouse.

FIG. 2 shows various states of a wheel of a conventional mouse.

FIG. 3 shows a diagram of electrical signals generated by the movement of a mouse.

FIG. 4 illustrates a diagram representing interior hardware of a mouse in accordance with one embodiment of the present invention.

FIG. 5A illustrates an embodiment of how the electrical energy generated by the movement of an input device may be used to provide energy for input device operations.

FIG. 5B illustrates another embodiment of how the electrical energy generated by the device movement may be used to provide energy for the device's operation.

FIG. 6 shows an example of a rectifier circuit.

FIG. 7 shows a key in accordance with one embodiment of the present invention.

FIG. 8 shows an alternative where multiple keys may be grouped to share a single coil in accordance with one embodiment of the present invention.

FIG. 9 illustrates a general purpose computer.

While specific embodiments are described and illustrated herein, these embodiments are not intended to limit the scope of the invention, which is susceptible to various modifications and alternative forms.

### DETAILED DESCRIPTION OF THE INVENTION

Methods and apparatus for a self-powered computer peripheral device are provided. When a peripheral device is set into motion by external energy, the mechanical energy from the motion of the device is converted into electrical energy by the device. The electrical energy is then used by the device to supply power to the internal circuitry of the device. Thus, no external or portable power sources are required for the device's operation.

A conventional peripheral device is typically connected to an RS-232 interface circuit of a computer by a physical wire. Data input to the computer by the peripheral device is accomplished by, e.g., an RS-232 interface circuit, inputting signals from the peripheral device into an RS-232C receiver chip in a host computer through the wire. Typically, the wire also carries the necessary power for the operation of the device's internal circuitry from the host computer to the peripheral device. For example, a typical serial mouse takes standard RS-232C output signals (e.g., +/−12V) from its host computer as its input signals through the wire. The mouse also takes current from each of the RS-232C port output lines the mouse is connected to (e.g., about 10 mA) which provides the necessary power for the operation of the internal circuitry of the mouse. Mouse electronics normally use approximately +5 V voltage and mouse outputs are normally approximately +/−5 V, 0.5 V or +/−12 V. Typical optomechanical mouse also needs power for the LEDs in the optocoupler movement detectors. A conventional cordless peripheral device, on the other hand, transmits data in wireless medium, e.g., radio or infrared, that does not require a physical wire as a communication channel. An internal power source such as a battery is typically required to provide the necessary power for the cordless device's operation. The invention described below may be applicable to both wired and cordless devices.

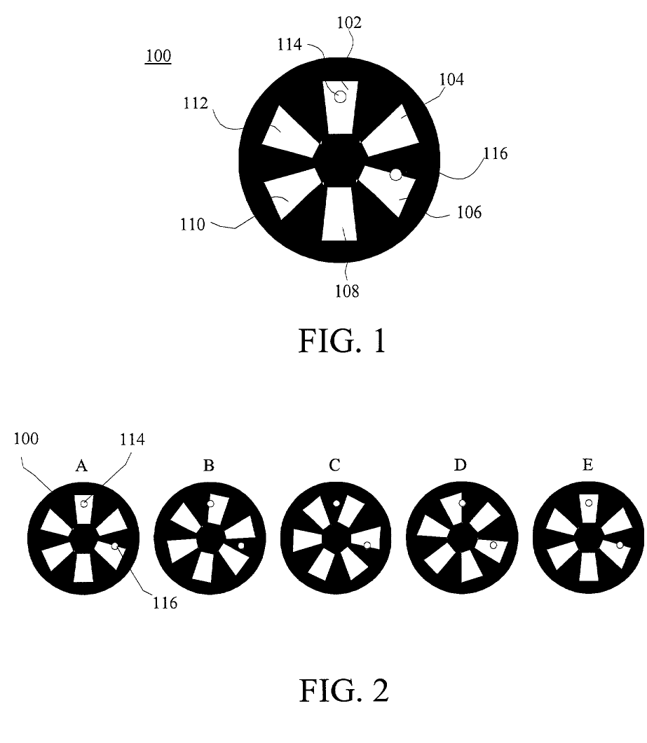

Mouse devices are used with computers typically as peripheral tools for selecting coordinates. To accomplish this, a conventional mouse typically includes two wheels, each similar to the one shown in FIG. 1. Wheel 100 is usually made of a non-transparent material (e.g., black plastic) with some slots (e.g., slots 102, 104, 106, 108, 110 and 112) punched in it. The size and shape of the slots may vary. For example, the slots may be rectangular in shape. In FIG. 1, six slots are shown at 60 degrees angle spacing for clarity and ease of explanation. However, there are typically more than six slots at closer spacing.

Shining through the slots are two light sources such as light emitting diodes (LEDs) shown as black dots 114 and 116. Each LED 114 and 116 shines onto a light sensor such as a light-sensitive transistor (not shown). The two LEDs 114 and 116 are spaced such that when one transistor can “see” its LED (e.g., LED 114) through the center of its slot (e.g., slot 102) and the other LED (e.g., LED 116) is looking at an edge (e.g., edge of slot 106) and is therefore switching on or off. The output voltage from the transistor is processed to switch rapidly from high to low as the LED's light is transmitted or occluded so that the voltage is low when the transistor is lit and high when the transistor is in darkness. For example, LED 114 is fully illuminated and LED 116 is switching. It may be noted that LED 116 may be switching during a light to dark transition or during a dark to light transition, depending on the rotation direction of wheel 100.

FIG. 2 shows wheel 100 in various states. For clockwise rotations, the states follow each other in order of A-B-C-D-E from left to right. Similarly, for counterclockwise rotations, the states follow each other in order of E-D-C-B-A from right to left. As wheel 100 rotates, LED 114 changes state from light (e.g., state A or state E) to dark (e.g. state C). For example, for a clockwise rotation, LED 114 changes state from light (state A) to dark (state C) and back to light (state E). Similarly, for a counterclockwise rotation, LED 114 changes state from light (state E) to dark (state C) to light (state A) again. Each time LED 114 changes from light to dark, LED 116 is sampled to determine the direction of movement. The number of transitions may be used to determine the distance of movement.

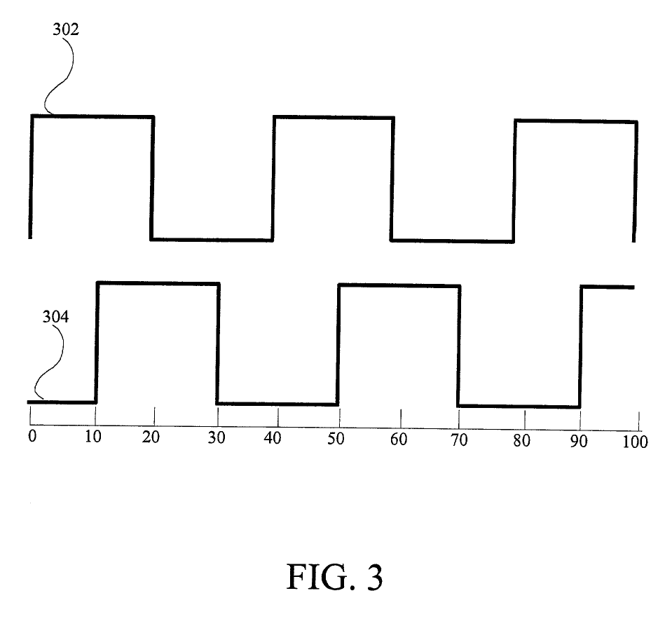

FIG. 3 shows a diagram of corresponding electrical signals switching at an interval corresponding to the slots on the wheels. Signal 302 and signal 304 indicate the relationship between electrical signals generated by a transmitter observing its LED. For example, signal 302 may be measured at time A and signal 304 may be measured at time B. The difference between the signals determines the direction of the mouse movement and the number of transitions can be used to calculate the distance of the wheel movement.

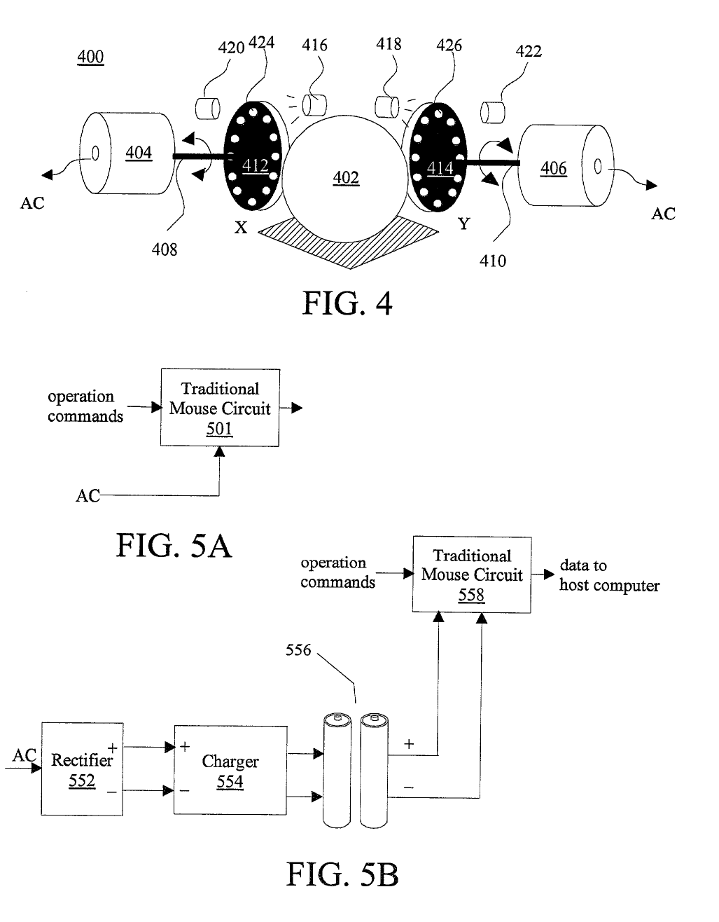

There are typically two wheels in a mouse, one wheel measures x-axis movement and the other wheel measures y-axis movement of the mouse ball in a horizontal plane. FIG. 4 shows a diagram representing interior hardware of a mouse in accordance with one embodiment of the present invention. Mouse 400 includes two wheels 412 and 414 touching a mouse ball 402. One wheel detects motion of the mouse ball in the x-axis direction and the other wheel, typically oriented at 90 degrees to the first wheel, detects motion of the mouse ball in the y-axis direction. When mouse ball 402 rolls, one or both wheels 412 and 414 roll as well. Wheels 412 and 414 are similar to the one described above in conjunction with FIGS. 1 through 3.

When the mouse ball rolls, its corresponding shaft and wheel spin. On either side of the wheel, there is a light source (e.g., a light emitting diode or an LED) and a light sensor. For example, wheel 412 has an associated light source 416 on one side of wheel 412 and a light sensor 420 on the other side of wheel 412. Similarly, wheel 414 has an associated light source 418 on one side of wheel 414 and a light sensor 422 on the other side of wheel 414.

Each wheel 412 and 414 has associated slots 424 and 426, respectively. The slots allow the beam of light coming from its respective light source to pass through while the remaining parts of the wheels break the beam of light. For example, slots 424 allows the beam of light coming from light source 416 to pass through while the remaining part as wheel 412 breaks the beam of light coming from light source 416. Light sensor 420 observes the pattern of light/dark transitions and generates a square pulse similar to that shown in FIG. 3. As described above, the rate of the pulses directly relates to the distance the mouse ball travels.

An on-board processor chip (not shown) reads the pulses from the light sensors and turns the pulses into binary data the host computer can understand. The on-board processor chip may contain circuitry that is of the same or similar construction as the internal circuitry of a conventional mouse. The on-board processor chip then sends the binary data to the host computer through a communication channel such as a wire or other communication mediums.

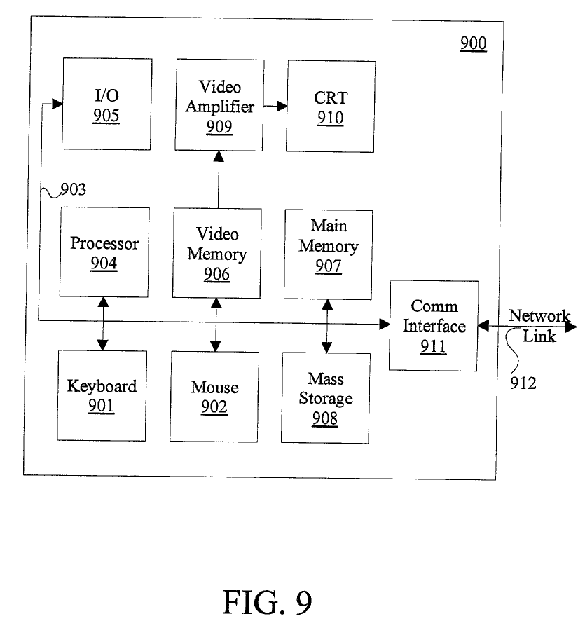

The host computer may be a general purpose computer as that shown in FIG. 9. A keyboard 901 and mouse 902 are coupled to a bi-directional system bus 903. Keyboard 901 and mouse 902 introduce user input to computer system 900 and communicate user input to a processor 904. Other suitable input devices may be used in addition to, or in place of, mouse 902 and/or keyboard 901. Mouse 902 and keyboard 901 may or may not be cordless. Input/output (I/O) unit 905 coupled to bi-directional system bus 903 represents I/O (peripheral) elements such as a printer, audio-video (A/V) I/Os, etc.

Bi-directional system bus 903 may contain, for example, thirty-two address lines for addressing a video memory 906 or a main memory 907. System bus 903 may also includes, for example, a 32-bit data bus for transferring data between and among components, e.g., processor 904, main memory 907, video memory 906 and mass storage 908, all coupled to bus 903. Alternatively, multiplex data/address lines may be used instead of separate data and address lines.

Processor 904 may be a SPARC microprocessor from Sun Microsystems, Inc., a microprocessor manufactured by Motorola (e.g., 680×0 processor) or a microprocessor manufactured by Intel (e.g., 80×86 or Pentium processor). Other suitable microprocessor or microcomputer may be utilized.

Main memory 907 may comprise dynamic random access memory (DRAM) or other suitable memories. Video memory 906 may be dual-ported video random access memory. For example, one port of video memory 906 may be coupled to a video amplifier 909 which is used to drive a monitor 910 which may be a cathode ray tube (CRT) raster monitor, a liquid crystal display (LCD), or any suitable monitors for displaying graphic images. Video amplifier 909 is well known in the art and may be implemented by any suitable apparatus. In one embodiment, pixel data stored in video memory 906 is converted to a raster signal suitable for use by monitor 910. Mass storage 908 may include both fixed and removable media, such as magnetic, optical or magnetic optical storage systems or any other available mass storage technology. Computer 900 may include a communication interface 911 coupled to bi-directional bus 903 for communicating to a local or remote network.

Referring to FIG. 4, a dynamo is coupled to each shaft. For example, dynamo 404 is coupled to shaft 408 and a dynamo 406 is coupled to shaft 410. Dynamo 404 and dynamo 406 may be any suitable machines or devices that convert mechanical energy (e.g., the turning of the shaft) into electrical energy by, e.g., magneto-electric induction. Because the mechanical energy involved may be on a small scale, the dynamo should be efficient so not to lose a significant amount of mechanical energy available. The electrical current generated by dynamos 404 and 406 may be alternating current (AC) which provides power needed by the mouse to operate. For example, the electrical energy generated by the movement of the mouse ball may provide power needed by the on-board processor chip to carry out its functions and to transmit signals to the host computer.

FIGS. 5A and 5B illustrate two embodiments of how the electrical energy generated by mouse ball movements may be used to provide energy for mouse operations. FIG. 5A shows an embodiment where the AC generated by the dynamos directly feeds into a mouse circuit 501. Mouse circuit 501 may be any mouse circuit. In this embodiment, the mouse and all its internal circuitry are in a “sleep state” (e.g., no energy) when it is in a stationary state. However, as soon as the mouse ball goes into motion, the dynamo starts to generate power which then “wakes up” the internal circuitry to perform its functions. For example, data may be transmitted from mouse circuit 501 to a host computer through a transmitter via a wire or other communication channels.

FIG. 5B shows an embodiment where the AC generated by the dynamos are stored in a power storage device 556 which is coupled to a traditional mouse circuit 558. The electrical current (AC) feeds into a rectifier 552. Rectifier 552 may be any conventional or suitable rectifier that converts alternating current into direct current (DC).

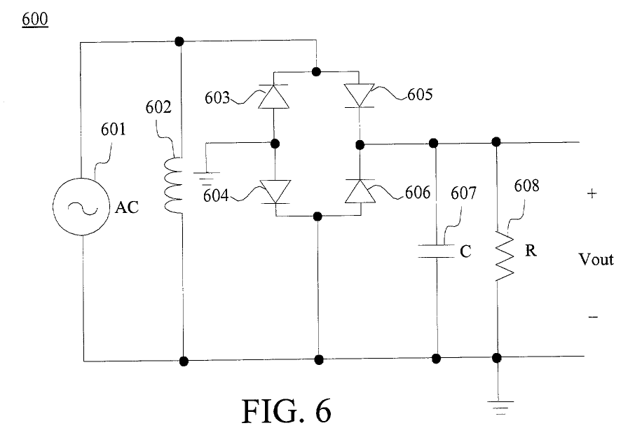

FIG. 6 shows an example of a rectifier circuit. Full-wave rectifier circuit 600 includes four diodes 603, 604, 605 and 606 which act as one-way valves. The diodes 603, 604, 605 and 606 form a bridge that is coupled to a filter capacitor 607 which is coupled in parallel with a load resistor 608. An inductor 602 is coupled across an AC source 601. Rectifier circuit 600 outputs a voltage Vout which may be supplied to other mouse circuit such as the on-board processor chip in the mouse. In general, rectifier circuit should be a low-loss rectifier.

Referring back to FIG. 5B, rectifier 552 is coupled to a charger 554. Charger 554 may be any conventional charging circuit suitable for charging power storage device 556 (e.g., batteries). Power storage device 556 may be, for example, any type of suitable rechargeable battery, including, but are not limited to, lead acid, nickel cadmium, nickel metal hydride, lithium ion, lithium polymer, zinc air and memory effect. Power storage device 556 is coupled to mouse circuit 558 which may be any suitable mouse circuit. By storing the power generated, excess power may be stored for future mouse operation or mouse operations that do not require device movement. For example, clicking of a mouse button (which initiate data to be transferred to the host computer) does not require mouse movement, thus does not cause power to be generated. However, the click typically is a command for initiating certain functions. In this situation, stored energy may be used to perform the requested function.

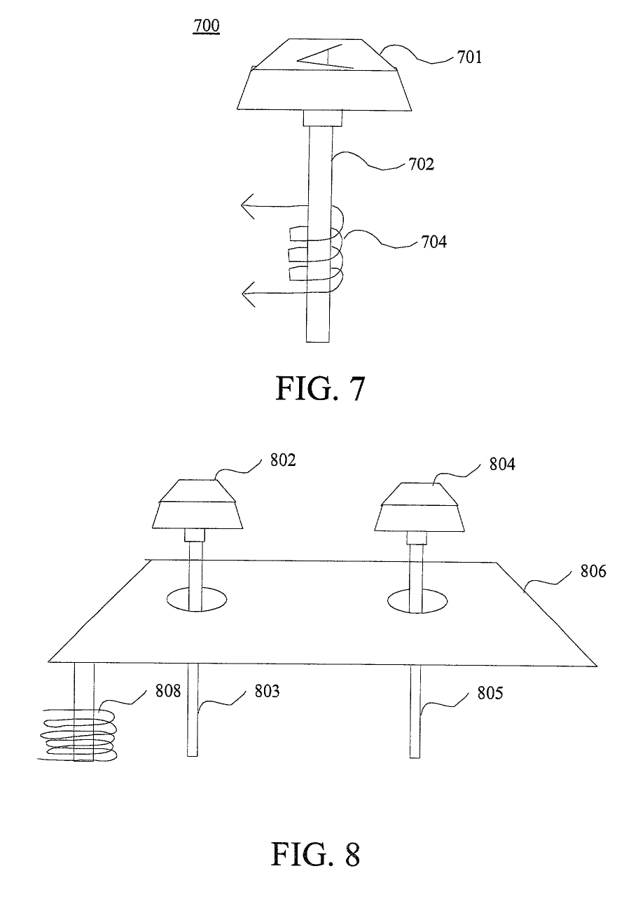

FIG. 7 shows a schematic of a key 700 in accordance with one embodiment of the present invention. Typically, key 700 has an associated switch which when closed, sends a signal to a host computer. Key 700 is typically associated with, e.g., a keyboard or a tablet. The keyboard or the tablet is usually connected to the host computer through a wire through which the host computer supplies power for the keyboard or the tablet's operation. Key 700 typically has a cap 701 and a shaft 702 coupled to the cap. When a user presses key 700 (cap 701), cap 701 moves downward, pushing shaft 702. In accordance with the present invention, a coil 704 may be placed along the shaft such that when key 700 is being pressed, the vertical movement of cap 701 and shaft 702 cause coil 704 to compress, thereby generating an AC signal that may be used for key operations, e.g., transmitting data to a host computer. The AC signal may also be stored in, e.g., batteries, as described above.

The energy generated by each key movement may vary depending on how much force is applied to cause the key movement, e.g., how hard or how quickly the key is being pressed. For example, in a situation where a key is being pressed with force, the coil may generate a strong signal. On the other hand, in a situation where a key is being lightly pressed, the associated coil may generate a weak signal, insufficient for key operation. In such situation, energy from each key may be pooled together.

FIG. 8 shows an embodiment where multiple keys may be grouped to generate AC signals using a single coil. When key 802 or key 804 is pressed, the respective shaft 803 or 805 moves and pushes against a tablet (or plate) 806 which in turn causes a coil 808 to generate an AC signal which provides power to, for example, a keyboard controller. Grouping of keys reduces the number of coils (dynamos) needed for a device. An optimal number of coils may be determined from, e.g., key usage, current generated by key stroke, etc.

A self-powered peripheral device does not need to rely on external power sources for its operation, such as the need to receive power from a host computer via a physical wire. Thus, the device may become cordless. A self-powered peripheral device may also eliminate power sources within the device. Thus, a cordless device may minimize its physical size and weight. In addition, the inconvenience of periodically interrupting device service to replace or recharge batteries may be eliminated because a battery is not required and even if a battery such as a rechargeable battery is present, the battery is automatically charged/recharged within the device itself without any external intervention.

While the present invention has been described with reference to particular figures and embodiments, it should be understood that the description is for illustration only and should not be taken as limiting the scope of the invention. Many changes and modifications may be made to the invention, by one having ordinary skill in the art, without departing from the scope of the invention.

What is claimed is:

1. A method of providing power to a computer peripheral device, comprising
converting mechanical energy generated by motion of said device into electrical energy; and
powering said device using said electrical energy.

2. The method of claim 1, further comprising generating said motion by human energy.

3. The method of claim 1, wherein said input device comprises a mouse.

4. The method of claim 3, wherein said mouse comprises a ball coupled to a shaft, further comprising:
coupling a power generator to said shaft; and
rotating said shaft using said mechanical energy.

5. The method of claim 4, wherein said power generator comprises a dynamo.

6. The method of claim 1, wherein said input device comprises a keyboard.

7. The method of claim 6, wherein said keyboard comprises at least one key coupled to a shaft, further comprising:
coupling a coil to said shaft; and
causing said coil to compress when said key is in motion.

8. The method of claim 6, wherein said keyboard comprises at least one key, further comprising coupling a coil to a group of keys such that said coil is compressed when one of said keys is in motion.

9. The method of claim 1, further comprising storing said electrical energy in an energy storing device.

10. The method of claim 9, further comprising storing said electrical energy in a rechargeable battery.

11. The method of claim 9, wherein said electrical energy comprises alternating current, said storing comprises:
converting said alternating current into direct current; and
charging said energy storing device.

12. A self-powered peripheral device, comprising a power generator for converting mechanical energy generated by motion of said device into electrical energy.

13. The device of claim 12, wherein said input device comprises a mouse.

14. The device of claim 13, said power generator comprises:
a ball;
a wheel proximate said ball;
a shaft coupled to said wheel; and
a dynamo coupled to said shaft.

15. The device of claim 12, wherein said input device comprises a keyboard.

16. The device of claim 15, wherein said power generator comprises:
a shaft coupled to a key; and
a coil coupled to said shaft.

17. The device of claim 15, wherein said power generator comprises:
at least one key;
a shaft coupled to each of said key;
a plate coupled to a plurality of said keys; and
a coil, wherein said at least one key causes motion to said plate and said shaft to compress said coil.

18. The device of claim 15, further comprising:
a rectifier circuit coupled to said power generator;
a charging circuit coupled to said rectifier circuit; and
an energy storing device coupled to said charging circuit.

19. The device of claim 18, wherein said energy storing device comprises a rechargeable battery.

20. A computer system, comprising:
a computer; and
a self-powered peripheral device coupled to said computer, said device comprising a power generator for converting mechanical energy caused by motion of said device into electrical energy.
